(19) United States
(12) Patent Application Publication
(10) Pub. No.: US 2002/0074011 A1
(43) Pub. Date: Jun. 20, 2002

(54) Interproximal contact marking floss

(76) Inventor: Noah R. Levi, Southfield, MI (US)

Correspondence Address: Amy E. Rinaldo, Kohn & Associates, Suite 410, 30500 Northwestern Hwy., Farmington Hills, MI, 48334, US

(21) Appl. No.: 09/888,771

(22) Filed: Jun. 25, 2001

Related U.S. Application Data
(60) Provisional application No. 60/213,823, filed on Jun. 23, 2000.

(51) Int. Cl. A61C 15/00; A61C 19/04

(52) U.S. Cl. 132/321; 433/68; 433/215

(57) ABSTRACT

According to the present invention, there is provided marking floss including dental floss impregnated with ink. Also provided is an abrasive floss including dental floss impregnated with an abrasive material. A method of marking teeth by running marking floss across the tooth in need of treatment thereby marking the areas in need of treatment is also provided. Also provided is a method of removing material from a tooth by running an abrasive floss across the tooth having excess material. A method of treating teeth by running a marking floss through the contact area in need of treatment, thereby marking areas in need of adjusting and running an abrasive floss through the contact area, thereby further adjusting the tightness of the contact.

### CROSS REFERENCE TO RELATED APPLICATIONS

This application claims the benefit of priority under 35 U.S.C. Section 119(e) of U.S. Provisional Patent Application No. 60/213,823, filed Jun. 23, 2000, which is incorporated herein by reference.

### BACKGROUND OF THE INVENTION

1. Technical Field

The present invention relates to dental instruments and materials and methods for using same in dental procedures. More specifically, the present invention relates to a kit containing instruments, devices and materials for facilitating the installation and fitting of artificial tooth crowns and inlays in a patient's mouth.

2. Background Art

Artificial dental crowns cover portions of a tooth surface and are normally fabricated away from the patient's mouth, in a lab, and then installed in the mouth. Full crowns form the entire occlusal surface of a tooth and the sides to the gum line. Partial crowns include onlays which cover the occlusal surface and sometimes portions of the sides, inlays which mainly cover central portions of the occlusal surface and may extend partially onto the sides, and veneers which mainly cover only a side surface of a tooth. For simplicity, all of these artificial elements for covering tooth surfaces will often be referred to as crowns in this document, but it should be recognized that each procedure discussed herein does not necessarily apply to all artificial crowns. In the field of fixed prosthodontics, the proper placement and adjustment of artificial crowns has always been a cumbersome process at best because it has necessitated placing several fingers of a dentist's hand within the patient's mouth during the process. This is because, as practiced now, the placement and fitting of an artificial tooth crown normally entails the dentist holding onto the crown with fingers of one hand, and then manipulating the crown in the patient's mouth to place, mark, fit and cement the crown. Often, the marking, fitting, and cementing requires fingers of the other hand to be placed into the patient's mouth as well.

Often an artificial crown is fashioned with the interproximal contacts somewhat tighter than necessary and then fitted by grinding and polishing it so that it will fit in proper contact with the adjacent teeth. Even if a crown is not made intentionally in the oversized manner, the crown may fit too tightly or too loosely because of errors due to impression materials and techniques, errors in stone dies and molds, changes in the dimension of the wax patterns, investing, casting, changes during porcelain firing, and other factors. Other causes of improper contacts are because the crown was incorrectly manufactured, or because the patient's teeth have moved slightly after the impression for the crown was made.

The interproximal contacts between an artificial crown must not be too tight or the adjacent teeth, which are attached flexibly to the jaw bone by the periodontal ligament, may spread apart and move out of alignment with the other teeth, including the artificially crowned tooth. Further, too tight of an interproximal contact may prevent the patient from being able to floss between the crowned tooth and the adjacent teeth, which could lead to gum disease and tooth decay. The contact fit must also not be too loose or the ensuing space between the artificially crowned tooth and the adjacent teeth will allow food and particulate matter to collect. The ideal fit is somewhere between a tight and loose fit, with light contact between the artificial crown or inlay and the surrounding teeth desired.

Many dentists use only dental floss to check whether interproximal crown contacts are too loose or too tight. This procedure is not accurate because of the thickness of floss is quite gross at best. The floss may also wedge the teeth apart and make it appear that the contact is proper.

Another method of checking the interproximal contact is by placing a non-marking thin plastic strip between the interproximal contact of the artificial crown and adjacent tooth and then seating the crown and pulling on the plastic ribbon to determine if the contact is too loose or too tight. This method is more precise than using floss, but is still very subjective, difficult to accomplish, and does not mark the contact point. This method also does not tell the operator precisely how strong the pressure is on each side of the crown.

Currently, the best method for checking the interproximal crown contact involves adjusting the contact fit of the artificial crown before its final cementing. This is done by holding the crown with two fingers, one on each side, reaching into the patient's mouth, and pressing the artificial crown onto the prepared tooth. While the crown is being placed on the tooth, a piece of thin marking ribbon is slipped with tweezers between the artificial crown and the adjacent tooth in front or behind the crown being placed. The dentist seats the crown fully onto the prepared tooth and pulls on the ribbon to remove it. An estimation of the tightness of the interproximal fit is made by estimating the pulling force necessary to remove the ribbon. This estimation is very subjective and not very accurate. Further, if the contact is too great, the ribbon will often tear when being removed. When the marking ribbon is removed, it will leave a small residue on the crown at any contact point between the adjacent tooth and the artificial crown being placed.

The artificial crown is then removed with the fingers or some dental tool such as extraction forceps or a sharp probe placed under a finish line margin of the crown. Use of these tools risks great damage to the crown. After the crown has been removed it can be ground and polished down at any heavy contact point for a more precise fit. As stated above, when using this process to estimate contact, the dentist must estimate the contact pressure. The dentist may therefore grind or polish the crown incorrectly on one or more of the sides, resulting in a finished crown which still fits improperly. This fitting method is problematic in that if there is excessive crown contact on one side of the crown only, the tooth to be crowned will shift and make the crown also contact the tooth on the opposite side. The dentist cannot always tell that this is occurring and will then grind both sides of the crown, only to find that when the large side is ground down and the tooth moves back, that the other side of the crown is no longer in contact.

If the crown is too small and there is a lack of contact, the dentist must send the crown back to the laboratory to have its size increased. The lab technician does not know how much too small the crown was and will thus greatly oversize the crown. The dentist will then later have to spend significant time resizing the crown.

This process of placing, checking, and adjusting is done repeatedly until the crown or inlay is fitted to the best of the dentist's abilities. The internal fit of the crown is then checked using a standard indicator paste or powder. Once the internal fit has been adjusted and deemed satisfactory, the occluding (biting) surface is then checked and adjusted. The crown is then cemented permanently onto the prepared tooth.

Patients often experience discomfort resulting from the introduction of multiple fingers into their mouth during the process of fitting an artificial crown. The dentist often has two fingers of one hand holding the crown and two fingers of the other hand holding and placing the ribbon, all in the mouth of the patient at the same time. Further, the fitting process is made difficult because of the tight quarters and the necessity of having so many fingers in the patient's mouth. The dentist not only has a difficult time maneuvering the crown and ribbon into place, especially when the tooth being crowned is in the rear of the mouth, but the dentist's view of the mouth is often blocked. Tweezers have been used to hold the testing ribbons, however, the tweezer jaws are at the wrong angle and are not designed for holding the ribbon flat. Further, tweezers do not readily aid the dentist in estimating the contact force when pulling the ribbon from the teeth.

The process of marking an artificial crown has been further complicated by the fact that past testing ribbons have not been designed for easy use. Previously, ribbons of paper or cloth have been used, but these are very thick and difficult to fit in between the adjacent teeth and the artificial crown being placed. Paper and cloth ribbons also loose their integrity when they encounter saliva. Further, paper, cloth, and even thin-plastic ribbons often come in large sheets or rolls from which the dentist or assistant must cut or tear small individual pieces, and then grip with fingers or tweezers for placement in the mouth.

These ribbon designs are very wasteful and cumbersome. When a dentist or assistant must hold a large ribbon sheet or roll and tear or cut it, the carbon or dye on the ribbon often becomes smeared and the ribbon crumpled. The possibility of contaminating the entire sheet or roll during the cutting and marking process often dictates that the remaining ribbon on the entire sheet or roll discarded. Hand cutting of the ribbon also leads to inconsistently sized ribbons. Further, because of electrostatic forces, small pieces of the cut ribbon often cling to each other, and gloves and tools, making them difficult to handle. Lastly, cut ribbons, especially those from rolls, often tend to curl, making them difficult to place.

Another problem which arises when the crowns are fitted by hand is contamination of the crown cement by substances on the dentist's latex gloves. Materials on the gloves such as zinc stearate, talc, corn starch and other substances which the manufacturers place on the gloves to keep them from sticking to each other act as contaminants in the cement.

Further, phosphoric acid and other chemicals such as eugenol in the cementing agent can dissolve or weaken latex gloves which come into contact with them. This creates a greater risk that a breach in the gloves will occur, possibly resulting in exposure of contaminants between the dentist and patient.

There is a need for an effective, yet less cumbersome, means for fitting artificial tooth crowns in a patient's mouth. There is also a need for marking floss which can be easily accessed with little waste or contamination. Lastly, there is a need for a marking, fitting method which will not contaminate the artificial tooth crown or inlay cementing process.

### SUMMARY OF THE INVENTION

According to the present invention, there is provided marking floss including dental floss impregnated with ink. Also provided is an abrasive floss including dental floss impregnated with an abrasive material. A method of marking teeth by running marking floss across the tooth in need of treatment thereby marking the areas in need of treatment is also provided. Also provided is a method of removing material from a tooth by running an abrasive floss across the tooth having excess material. A method of treating teeth by running a marking floss through the contact area in need of treatment, thereby marking areas in need of adjusting and running an abrasive floss through the contact area, thereby further adjusting the tightness of the contact.

### DESCRIPTION OF THE DRAWINGS

Other advantages of the present invention are readily appreciated as the same becomes better understood by reference to the following detailed description when considered in connection with the accompanying drawings wherein:

FIG. 1 shows a crown attached to the tooth using a 100% seat prior to cementation of the crown;

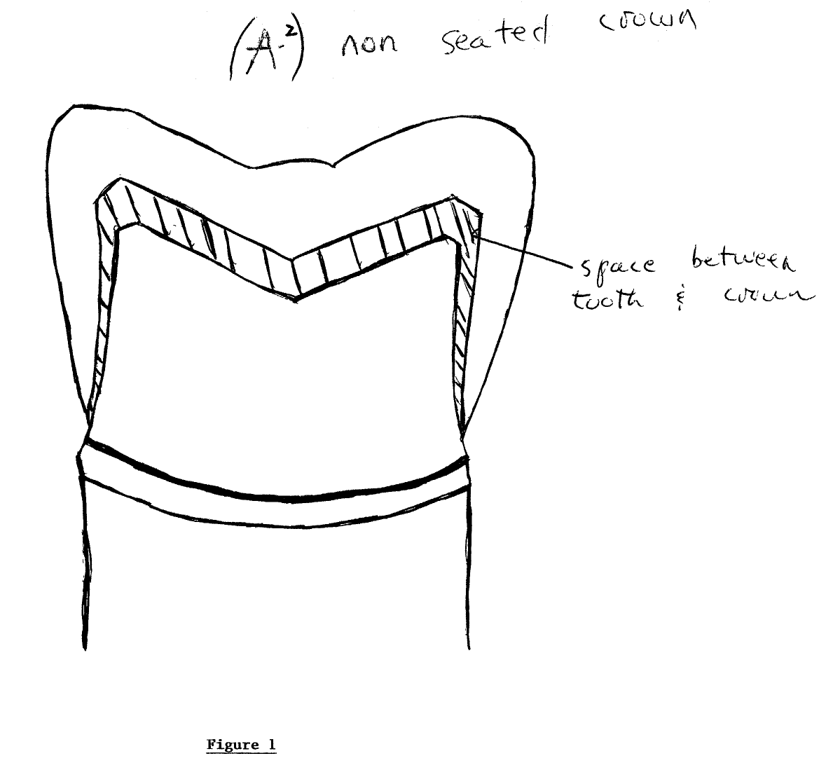

FIG. 2 shows a new crown which the contact to adjacent teeth have too much porcelain or metal thereby keeping the crown from seating;

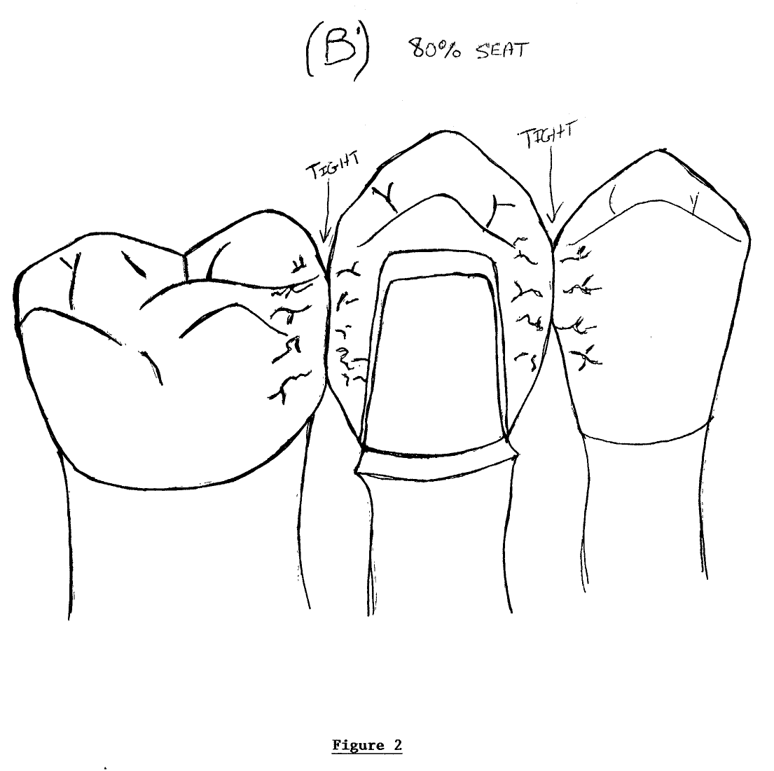

FIG. 3 shows the method of the present invention; and

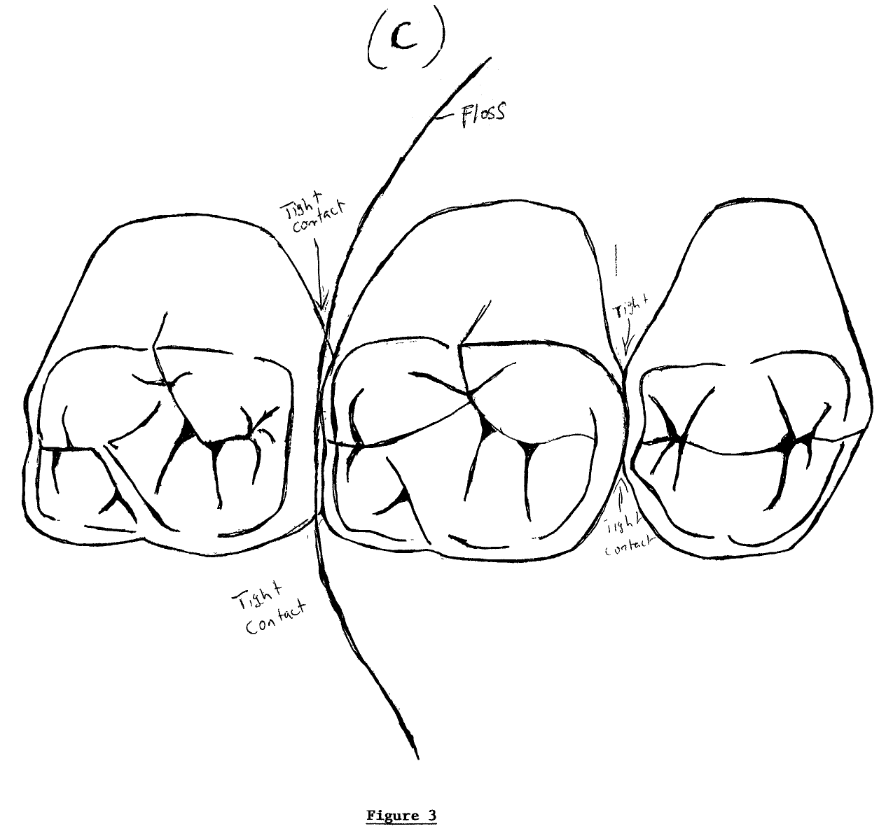

FIG. 4 shows the marking of a high spot thereby indicating adjustment.

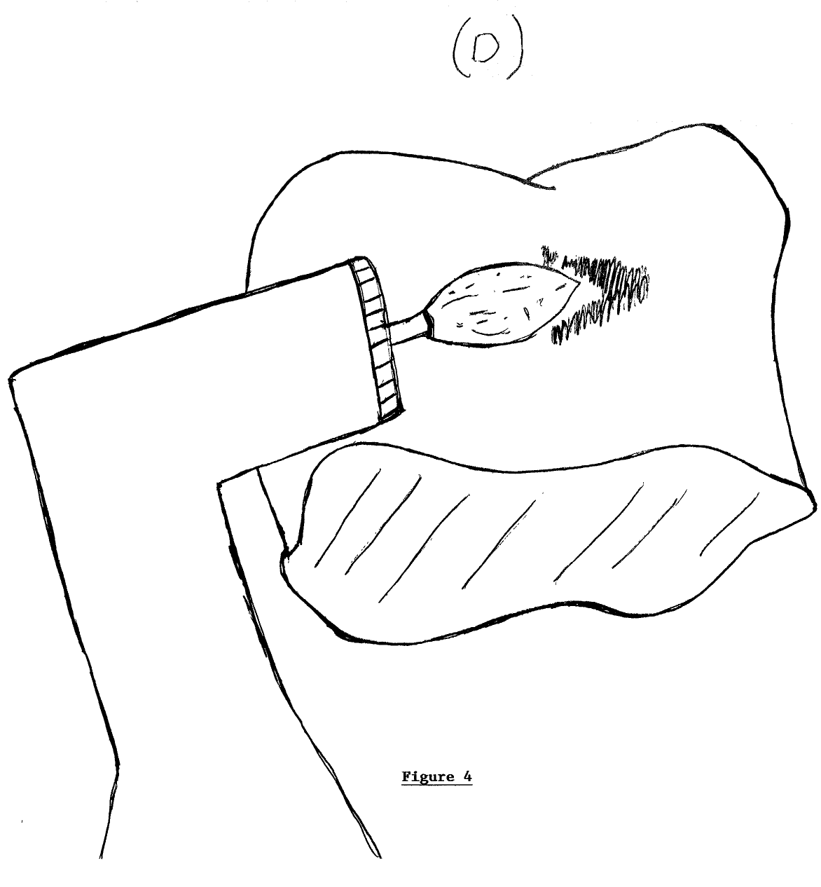

### DETAILED DESCRIPTION OF THE INVENTION

The present invention provides dental floss for marking teeth. The dental floss is an elongate uninterrupted strand of material, such as an elastomer or acrylic material having a predetermined diameter and impregnated or coated with a dye.

The dye can include, but is not limited to, any one of a variety of substances well known in the art for marking teeth. The dye enables the dentist to accurately determine interproximal spacing between the teeth and proper fitting of a crown by observing the stained areas on the teeth.

The precise nature of the dye is not critical to the invention. In general, the dye should be selected so as to be non-toxic to the patient in small quantities and to produce a color that is readily distinguishable from the overall color of the teeth.

The dental floss can be impregnated or coated with the pressure dye by immersing the dental floss in an emulsion containing the dye and then drying the dental floss as described in U.S. Pat. No. 2,299,693 herein incorporated by reference.

In another embodiment, the dye contains chemically interactive materials, such as pH indicators as described in U.S. Pat. No. 3,918,160 referenced above. For example, an acid-base indicator, such as phenophthalein can be utilized as one of the interactive materials and the other material can include, but are not limited to, be sodium-tetraborate.

In another embodiment, the dye can include a plurality of micro-capsules dispersed in a carrier of a type well known in the art. The term “micro-capsule” designates the class of materials wherein a nucleus or microscopic drop of liquid material is surrounded by a mantle of relatively impervious material. The mantle is relatively thin and pressure sensitive so as to be ruptured easily when pressure is applied.

In view of the foregoing, it can be appreciated that the invention is not limited by the chemically interactive material used to indicate the stained areas on the teeth and that the invention can be practiced with any dye that is non-toxic to the patient and produces a color that is readily distinguishable from the overall color of the teeth.

It should also be appreciated that the diameter of the dental floss according to the invention can be of different predetermined diametral thickness depending on the interproximal spacing between the teeth to be indicated by the pressure sensitive material. In the preferred embodiment, the dental floss has a substantially uniform cross sectional area of a circular shape. Typically, the diameter of the dental floss may be between approximately 0.25 and 10 mils thickness. The floss can be round string, flat string, combination string floss, or any other floss known to those of skill in the art.

For example, the floss of the present invention can include a single relatively thick strand of expanded polytetrafluoroethylene (PTFE) fiber that is essentially rectangular to oblong in cross-sectional dimensions and is formed substantially without folds or creases. In order to form the floss without folding one or both of its edges over itself, as is required with existing flosses. The floss of the present invention can be formed to have a significantly greater thickness dimension than presently available PTFE floss fibers. For example, prior to folding, conventional expanded PTFE floss fiber sold under the trademark GLIDE.RTM. by W. L. Gore & Associates, Inc., has typical dimensions of about 40 μm in thickness and about 2 mm in width. When this material is folded and packaged as dental floss, the material typically has dimensions of about 90 μm in thickness and about 1.2 mm in width. The PTFE floss sold under the name EASY SLIDE by Johnson & Johnson has typical unfolded dimensions of about 23 μm in thickness and about 2.3 mm. When this material is folded and packaged as dental floss, the material typically has dimensions of about 75 μm in thickness and about 1.3 mm in width.

Also provided by the present invention is an abrasive floss which is a dental floss impregnated with an abrasive material. The abrasive material can include, but is not limited to, abrasive granules and abrasive beads of abrasive grit. The abrasive floss can be used to finish dental restorations. The floss can also be used to remove an excess cement and flash left over from the cementation process. The floss works by picking a specific size floss or discolored above which contain the abrasive material and fine tuning the contact after cementation.

When used together, the two flosses of the present invention provide a novel means for finely tuning the fitting of the artificial crown or the like. For example, during the fitting process the practitioner can first mark the area in need of fine grinding with the dye impregnated floss and after placing the crown in place further adjusting the spacing between the crown and the adjacent tooth. The abrasive floss can therefore be used to ensure proper spacing in the contact area between the teeth. A larger diameter floss can be used in more material needs to b removed subsequent to cementation. The gauge of the grinding floss ensures exact spacing. Thus, the two types of floss can work together or individually to effect a desired result.

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology which has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

What is claimed is:

1. Marking floss comprising dental floss impregnated with ink.

2. The marking floss according to claim 1, wherein said ink is selected from the group consisting essentially of dye, chalk, and impregnatible inks.

3. The marking floss according to claim 1, wherein said dental floss is selected from the group consisting essentially of round string, flat string, and combination string floss.

4. Abrasive floss comprising dental floss impregnated with an adhesive material.

5. The abrasive floss according to claim 4, wherein said dental floss is selected from the group consisting essentially of round string, flat string, and combination string floss.

6. The abrasive floss according to claim 4, wherein said abrasive material is selected from the group consisting essentially of abrasive granules and abrasive beads.

7. A method of marking teeth, in need of adjusting treatment by running and marking floss according to claim 1 through the contact area, thereby marking areas in need of adjusting.

8. A method of removing material from a contract area tooth by running an abrasive floss through the contact area.

9. A method of treating teeth by running the marking floss through a contact in need of treatment, thereby marking areas in need of adjusting and running an abrasive floss through the contact areas, thereby further adjusting the tightness of the contact,
